(19) United States
(12) Patent Application Publication
(10) Pub. No.: US 2009/0118043 A1
(43) Pub. Date: May 7, 2009

(54) VARIABLE DIAMETER GEAR DEVICE AND VARIABLE TRANSMISSIONS USING SUCH DEVICES

(75) Inventors: Nimrod EITAN, Tel Aviv (IL); Nathan Naveh, Kfar-Mass (IL); Joseph Rogozinski, Ramat Gan (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: IQWind Ltd., Herzelia (IL)

(21) Appl. No.: 12/204,027

(22) Filed: Sep. 4, 2008

Related U.S. Application Data
(60) Provisional application No. 60/996,108, filed on Nov. 1, 2007.
(60) Provisional application No. 61/082,533, filed on Jul. 22, 2008.

(51) Int. Cl. F16H 9/10; F16H 59/06

(52) U.S. Cl. 474/56; 474/49; 474/50

(57) ABSTRACT

A variable diameter gear device for use in a variable ratio transmission system includes a gear tooth set deployed around an axle which defines an axis of rotation. The gear tooth set includes at least two displaceable gear tooth sequences, each including a multiple gear teeth spaced at a uniform pitch, and a diameter changer mechanically linked to the axle and to the gear tooth set. The diameter changer is deployed to transfer a turning moment between the axle and the gear tooth set, and to displace the gear tooth set so as to vary a degree of peripheral coextension between the gear tooth sequences. Specifically, the diameter changer transforms the gear device between at least two states in which the gear tooth set is deployed to provide an effective cylindrical gear with differing effective numbers of teeth. The gear device may be used either in direct engagement with another gear wheel or as part of a chain-based transmission system.

This application claims the benefit of Provisional Patent Application No. 60/996,108 filed Nov. 1, 2007, and Provisional Patent Application No. 61/082,533 filed Jul. 22, 2008.

### FIELD AND BACKGROUND OF THE INVENTION

The present invention relates to variable transmissions and, in particular, it concerns a variable diameter gear device and variable transmissions using such devices.

A transmission transfers rotational power between an input shaft and an output shaft, and defines a transmission ratio between a rate of rotation at the input shaft and the corresponding rate of rotation at the output shaft. This ratio may be less than one where output rotation is slower, but higher torque, than the input, may be equal to one where the input and output rotate at the same rate, or may be greater than one where the output rotates faster, but with lower torque, than the input. The transmission may be bidirectional, i.e., allowing an input in either a clockwise or an anticlockwise rotational direction, and may be reversible, i.e., where the “output” may be rotated to transfer power to the “input”.

In many circumstances, it is desirable or necessary to provide a variable transmission, i.e., where the transmission ratio can be changed. Examples include vehicles, where a variable output speed is needed while maintaining the power source operating as near as possible to its optimal speed for the required power output, and power generators, where it may be preferably to maintain a constant output speed despite variations in the power of a source of mechanical power being harnessed.

In transmission systems based on gear wheels (either in direct engagement or via chain linkages), the transmission ratio between two gear wheels is defined by the ratio between the number of gear teeth in each. Thus, if an input shaft has a gear wheel with n₁=60 teeth and drives, directly or via a chain, an output shaft gear with n₂=30 teeth, the transmission ratio TR will be n₁/n₂=2, and the output shaft will turn 2 revolutions for each revolution of the input shaft. In order to vary the transmission ratio, a set of gear wheels with differing numbers of teeth are typically provided. However, switching engagement from one gear wheel to another is problematic. There is typically a momentary loss of driving relation between the input and the output, as in a traditional “manual” automobile transmission, and/or the shift may result in a sudden jolt or reduced reliability, such as in a derailer gear system common in bicycles. None of the available options for switching engagement between multiple gear wheels provides for a reliable and smooth transition between transmission ratios without momentary loss of driving engagement.

As an alternative to switching between gears, various transmissions have been proposed which employ variable diameter pulleys or conical drive elements with corresponding belts to achieve variable transmission ratios. However, gradual variations of diameter can typically only be achieved in toothless friction-based systems. Reliance on frictional transfer of torque introduces its own set of problems, including loss of torque through slippage, and mechanical wear and unreliability due to high tension required to maintain frictional engagement.

Various attempts have been made to design a gear wheel which would provide a variable diameter and variable effective number of teeth. Particularly for bicycles, many designs have been proposed in which segments of a gear wheel can be moved radially outwards so that the segments approximate to rounded corners of a toothed polygon with variable spaces therebetween. These designs can engage a chain and have a variable effective number of teeth where the spaces correspond to “missing” teeth. Examples of such designs may be found in U.S. Pat. Nos. 2,782,649 and 4,634,406, and in PCT Patent Application Publication No. WO 83/02925. This approach generates a non-circular effective gear which has missing teeth between the gear wheel segments. As a result, it is clearly incompatible with direct engagement between gearwheels. Even when used with a chain, the rotating polygonal shape would cause instability and vibration if used at significant speeds and does not provide uniform power transfer during rotation.

A further variant of the aforementioned approach is presented in German Patent Application Publication No. DE 10016698 A1. In this case, sprocket teeth are provided as part of a flexible chain which is wrapped around a structure of radially displaceable segments. The chain is anchored to one of the displaceable segments and a variable excess length at the other end of the chain is spring-biased to a recoiled storage state within an inner volume of the device. This structure would appear to be an improvement over the aforementioned documents in the sense that sprocket teeth are provided spanning the gaps between the radially displaceable segments. However, since there is still a gap between the teeth where the chain enters the inner storage volume, and since the proposed structure still fails to maintain a circular profile, it still shares most if not all of the aforementioned disadvantages of the radially displaceable segment designs: it cannot be used in direct engagement with a gearwheel and does not provide uniform power transfer during rotation.

There is therefore a need for a variable diameter gear device which would provide a variable effective number of teeth while maintaining circular symmetry and allowing continuous direct engagement with another gear wheel.

### SUMMARY OF THE INVENTION

The present invention is a variable diameter gear device and variable transmissions using such devices.

According to the teachings of the present invention there is provided, a variable diameter gear device for use in a variable ratio transmission system, the variable diameter gear device comprising: (a) an axle defining an axis of rotation; (b) a gear tooth set deployed around the axle, the gear tooth set including at least: (i) a first displaceable gear tooth sequence including a plurality of gear teeth spaced at a uniform pitch, and (ii) a second displaceable gear tooth sequence including a plurality of gear teeth spaced at the uniform pitch; and (c) a diameter changer mechanically linked to the axle and to the gear tooth set so as to transfer a turning moment between the axle and the gear tooth set, the diameter changer configured to displace the gear tooth set so as to vary a degree of peripheral coextension between at least the first and the second gear tooth sequences, thereby transforming the gear device between: (i) a first state in which the gear tooth set is deployed to provide an effective cylindrical gear with a first effective number of teeth, and (ii) a second state in which the gear tooth set is deployed to provide an effective cylindrical gear with a second effective number of teeth greater than the first effective number of teeth.

According to a further feature of the present invention, the diameter changer is further configured to displace the gear tooth set so as to vary a degree of peripheral coextension between at least the first and the second gear tooth sequences so as to selectively transform the gear device to each of a plurality of intermediate states each providing an effective cylindrical gear with a corresponding integer effective number of teeth assuming a value between the first and the second effective numbers of teeth.

According to a further feature of the present invention, the diameter changer is configured to position all of the gear teeth of the gear tooth set on a virtual cylinder coaxial with the axle in each of the first and the second states.

According to a further feature of the present inventions each of the tooth sequences is implemented as a strip of gear teeth interconnected so as to maintain the uniform pitch while accommodating a variable radius of curvature between the first and the second states.

According to a further feature of the present invention, the diameter changer transfers a turning moment between both the first and the second gear tooth sequences and the axle via a single mechanical linkage.

According to a further feature of the present invention, the diameter changer transfers a turning moment between the first and the second gear tooth sequences and the axle via separate mechanical linkages angularly spaced around the axle.

According to a further feature of the present invention, the gear tooth set has a single region with a variable degree of peripheral coextension between the gear tooth sequences.

According to a further feature of the present invention, the gear tooth set has a plurality of regions with a variable degree of peripheral coextension between the gear tooth sequences.

According to a further feature of the present invention, the diameter changer includes at least one substantially conical element engaged with at least one of the gear tooth sequences such that axial displacement of the substantially conical element changes a distance of the gear teeth of the at least one gear tooth sequence from the axis.

According to a further feature of the present invention, the substantially conical element has a stepped conical surface.

According to a further feature of the present invention, the substantially conical element has a smooth conical surface.

According to a further feature of the present invention, the diameter changer includes at least one pair of slotted disks associated with the axle, and a plurality of pins associated with at least one of the gear tooth sequences and engaged in the slots, the slotted disks being configured such that relative rotation of the slotted disks about the axis changes a distance of the gear teeth of the at least one gear tooth sequence from the axis.

According to a further feature of the present invention, the diameter changer includes a sensor deployed to generate an output indicative of an effective diameter of the variable diameter gear device, the diameter changer being responsive to the output to adjust the gear tooth set to provide an effective cylindrical gear with an integer effective number of teeth.

According to a further feature of the present invention, the diameter changer includes: (a) a sensor deployed to generate an output indicative of a current angular position of the axle; and (b) a controller responsive to the output to selectively perform the transforming while the axle is within a permitted range of angular positions.

According to a further feature of the present invention, there is also provided: (a) an idler gear wheel deployed for rotation about an idler axle, the idler gear wheel including a plurality of gear teeth configured for engaging the gear wheel sequences; and (b) an idler displacer associated with the idler axle and configured to move the idler axle so as to maintain engagement of the idler gear wheel with the gear tooth set while the effective number of teeth is varied.

According to a further feature of the present invention, there is also provided a chain deployed in engagement with a plurality of gear teeth of the gear tooth set so as to maintain a driving engagement with the gear teeth during transformation between the first and the second states.

### BRIEF DESCRIPTION OF THE DRAWINGS

The invention is herein described, by way of example only, with reference to the accompanying drawings, wherein:

FIGS. 1A and 1B are schematic side views of a first and a second displaceable gear tooth sequence, respectively, from a variable diameter gear device, constructed and operative according to the teachings of the present invention, the displaceable gear tooth sequences being shown in a first radially expanded state;

FIG. 1C is a schematic side view of a variable diameter gear device, constructed and operative according to the teachings of the present invention, including the displaceable gear tooth sequences of FIGS. 1A and 1B in their first radially expanded state;

FIGS. 2A, 2B and 2C are views similar to FIGS. 1A, 1B and 1C, respectively, with the displaceable gear tooth sequences in a radially smaller state;

FIGS. 3A, 3B and 3C are views similar to FIGS. 1A, 1B and 1C, respectively, with the displaceable gear tooth sequences in a fully closed state;

FIGS. 4A-4E are a series of schematic side views of the variable diameter gear device of FIG. 1C illustrating a transition of the device from an effective gear of 28 teeth to an effective gear of 29 teeth;

FIGS. 5A-5E are schematic flattened gear tooth sequences illustrating a plurality of optional layouts with differing numbers of regions of variable peripheral coextension;

FIG. 6 is a view illustrating a first particularly preferred embodiment of a diameter changer for adjusting the effective diameter of the gear devices of the present invention;

FIG. 7A is an isometric view of the axially displaceable cones of the diameter changer of FIG. 6, further illustrating a set of sensors associated with the diameter changer;

FIG. 7B is a block diagram illustrating a possible control loop for controlling operation of the axially displaceable cones of FIG. 7A;

FIGS. 8A and 8B are schematic side views of an intermeshed gear transmission system employing the variable diameter gear device of FIG. 1C together with an idler gear, the system being shown with the variable diameter gear device in a first state, having a first effective number of teeth, and a second state having a second effective number of teeth greater than said first effective number of teeth, respectively;

FIG. 9 is a block diagram illustrating a possible control loop for controlling the position of the idler gear in the transmission system of FIGS. 8A and 8B;

FIG. 10 is a schematic representation of a computerized control system for controlling a transmission system, constructed and operative according to the teachings of the present invention, including the variable diameter gear device of FIG. 1C;

FIGS. 11A and 11B are schematic side views of a chain-based transmission system employing the variable diameter gear device of FIG. 1C together with an output gear and an adaptive chain tensioning arrangement, the system being shown with the variable diameter gear device in a first state, having a first effective number of teeth, and a second state having a second effective number of teeth greater than said first effective number of teeth, respectively;

FIG. 12 is a block diagram illustrating a possible control loop for controlling the adaptive chain tensioning arrangement in the transmission system of FIGS. 8A and 8B;

FIG. 13 is an isometric view of an alternative embodiment of a transmission system, constructed and operative according to the teachings of the present invention, employing two variable diameter gear devices interlinked by a drive chain;

FIG. 14A is an isometric view of one of the variable diameter gear devices of FIG. 13;

FIGS. 14B and 14C are isometric views of the variable diameter gear device of FIG. 14A in an ‘open’ and ‘closed’ position, respectively, without a restriction mechanism;

FIG. 15 is an enlargement of detail designated “A” in FIG. 14B, with addition of a restriction mechanism;

FIGS. 16A-16D are isometric views of a full, male, female and combined base link constituting a part of the gear device of FIG. 14A;

FIGS. 17A and 17B are isometric and front views respectively of the full base link shown in FIG. 16A;

FIGS. 18A and 18B are front views of portions of the gear device of FIGS. 14B and 14C, respectively;

FIGS. 19A and 19B are an isometric and front view, respectively, of a partial base link shown in FIG. 16C with a restricting link thereon;

FIG. 19C is an isometric view of several partial base links shown in FIGS. 19A and 19B when interconnected;

FIG. 20 is an isometric view of a transmission chain;

FIG. 21 is an isometric view of a portion of the gear device of FIG. 14A with the transmission chain shown in FIG. 19D mounted thereon;

FIG. 22A is an isometric view of a portion of one of the gear devices of FIG. 13 with the diameter changing mechanism, in a ‘closed’ position;

FIG. 22B is an isometric view of the portion of the portion of the gear device of FIG. 22A with the diameter changing mechanism, in an ‘open’ position; and

FIG. 23 is an isometric view of a base link mounted on the diameter changing mechanism of FIGS. 22A and 22B to form a torque transferring linkage.

### DESCRIPTION OF THE PREFERRED EMBODIMENTS

The present invention is a variable diameter gear device and variable transmissions using such devices.

The principles and operation of variable diameter gears and corresponding transmission systems according to the present invention may be better understood with reference to the drawings and the accompanying description.

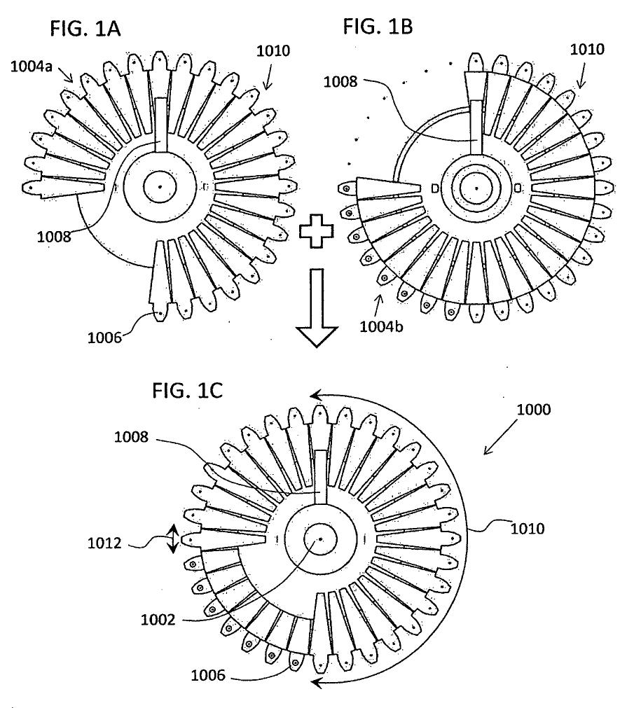

Referring now to the drawings, FIGS. 1A-3C illustrate the underlying principles of operation of a variable diameter gear device, generally designated 1000, constructed and operative according to the teachings of the present invention, for use in a variable ratio transmission system. Generally speaking, variable diameter gear device 1000 has an axle 1002 defining an axis of rotation and a gear tooth set 1004 deployed around the axle. Gear tooth set 1004 includes at least a first displaceable gear tooth sequence 1004a and a second displaceable gear tooth sequence 1004b, each including a plurality of gear teeth 1006 spaced at a uniform pitch. A diameter changer, represented here schematically by rectangle 1008 and described further below, is mechanically linked to axle 1002 and to gear tooth set 1004 so as to transfer a turning moment between axle 1002 and gear tooth set 1004.

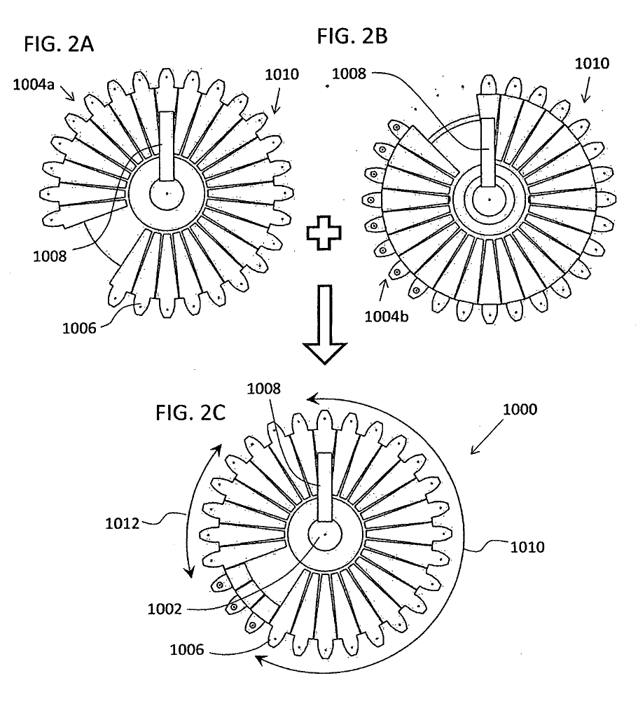

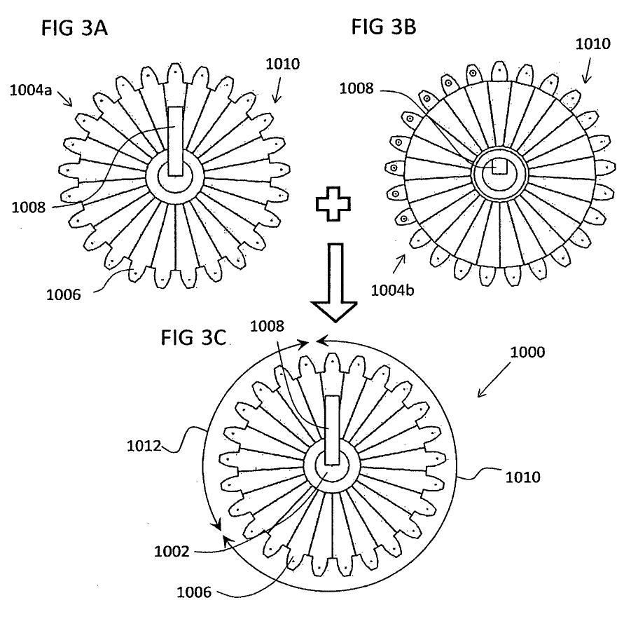

Diameter changer 1008 is configured to displace gear tooth set 1004 so as to vary a degree of peripheral coextension between at least the first and the second gear tooth sequences 1004a and 1004b, thereby transforming the gear device between at least two states in which gear tooth set 1004 forms an effective cylindrical gear with differing effective numbers of teeth. Thus, by way of example, in FIG. 1C, gear tooth sequences 1004a and 1000b have a region of fixed overlap 1010 corresponding to 17 gear teeth, and a region of variable overlap 1012 shown here with 1 tooth overlapping. The result is an effective cylindrical gear wheel with 32 effective teeth. FIG. 2C illustrates an adjusted state where region 1012 has 5 teeth overlapping, corresponding to an effective cylindrical gear wheel with 28 effective teeth. FIG. 3C shows a fully closed configuration in which region 1012 has 8 teeth overlapping, giving an effective cylindrical gear wheel with 25 effective teeth. The range of numbers of effective teeth may range from a maximum in a state of zero overlap between the tooth sequences down to a minimum corresponding to a state of complete closure such that one or more of the toot sequences is closed on itself, or may span only a subset of this range.

At this stage, it will already be apparent that the present invention provides profound advantages. Specifically, by employing variable overlap between at least two gear tooth sequences, the present invention provides a variable effective number of teeth while allowing continuous toothed engagement around the entire periphery of the effective cylindrical gear wheel in each state. This and other advantages of the present invention will become clearer from the following detailed description and examples.

It will be helpful at this point to define certain terminology as used herein in the description and claims. Firstly, reference is made to an “effective cylindrical gear” to refer to a structure which is capable of providing continuous toothed engagement with a simple or compound cylindrical idler gear. The individual gear sequences of the present invention typically have spaces in them, as illustrated in FIGS. 1A and 1B. However, when used together, as illustrated in FIG. 1C, they allow continuous engagement around the entire revolution of the gear device. It will be noted that the present invention may be used to advantage in transmissions based on directly engaged gear wheels and in chain-based transmissions, as detailed below. However, even in the chain-based implementations, it is considered helpful to refer to an idler gear as a theoretical construct which may be used to define the geometrical properties of gear device 1000.

An “idler gear” in this context is any gear configured for toothed engagement with gear device 1000. The term “idler gear” is used to reflect a typical arrangement in which the idler gear is an intermediate component in a gear train, but without excluding the possibility of the “idler gear” being directly connected to a power input or power output axle. The idler gear may be a simple idler gear, i.e., a standard gear which is implemented with teeth sufficiently wide to engage the plurality of tooth sequences. Alternatively, for some implementations, a “compound idler gear” would be required, in which two or more gear wheels are mounted so as to rotate together with a common idler axle. The gear wheels making up a compound idler gear are typically identical and in-phase (i.e., with their teeth aligned), but may be implemented as out-of-phase (non-aligned teeth) gear wheels if a corresponding phase difference is implemented between the tooth sequences.

The terms “gear teeth” and “gear wheel” are used herein generically to refer to any and all formations on a rotating body, and the corresponding rotating body, configured for engagement with corresponding formations on another gear wheel or with links in a chain to provide positive rotational engagement between the rotating body and the other gear wheel or chain. The terms thus defined refer generically to gears, cogs and sprockets of all kinds, and their corresponding teeth.

Reference is made to gear teeth in each gear tooth sequence having a “uniform pitch”. The “uniform pitch” here is defined functionally by the ability to mesh with a given idler gear or chain across the entire range of variable diameters of gear device 1000. It will be noted that the geometrical definition of the “pitch” is non-trivial since the radius of curvature of the tooth sequences varies between states, and thus the distance between the tips of adjacent teeth typically vary as the gear device is adjusted. Furthermore, the angular pitch between adjacent teeth necessarily varies as the radial position of the tooth sequences varies. As a non-limiting exemplary geometrical definition, in some cases, it may be advantageous to maintain a constant distance between the geometrical centers (defined as the intersection of the standard pitch circle and a center line of the tooth) of adjacent gear teeth during adjustment of the gear device. Nevertheless, various alternative implementations may equally provide the desired functionality of enabling meshing with a given idler gear over the entire range of variable diameters, and therefore also fall within the definition of “uniform pitch” according to the present invention.

Reference is made to an “effective number of teeth” of gear device 1000 in each state. The effective number of teeth in any given state is taken to be 2π divided by the angular pitch in radians between adjacent teeth about the axis of rotation. In intuitive terms, the effective number of teeth corresponds to the number of teeth that would be in a simple gear wheel which would function similarly to the current state of gear device 1000. In most cases, where the teeth of each gear tooth sequence are aligned in-phase with other teeth, the effective number of teeth is simply the number of teeth of the combined gear tooth set as projected along the axis.

Reference is made to a “gear tooth sequence”. This refers generically to any strip, chain or other support structure which maintains the required spacing between the teeth around the periphery of the gear device in its various different states.

Finally with regard to definitions, reference is made to a “degree of peripheral coextension” between two gear tooth sequences. the degree of peripheral coextension corresponds to the angular extent of coextension of the gear tooth sequences around the periphery of the effective cylindrical gear, independent of the current diameter of the cylinder. When reference is made to a variable degree of peripheral coextension, this includes the possibility of the coextension being reduced to zero, i.e., where one tooth sequence provides one tooth and another provides the next tooth without any overlap therebetween.

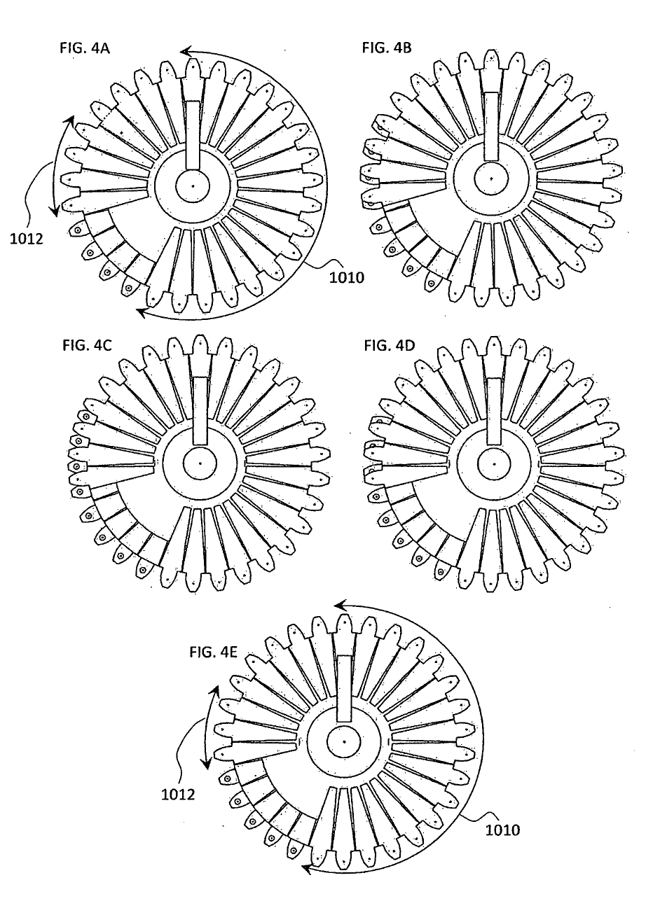

Turning now to FIGS. 4A-4E, this shows a sequence illustrating a transition from one state of gear device 1000 to another state, in this case incrementing the effective number of teeth by one. It will be noted that, in the region of variable overlap 1012, the teeth of the tooth sequences become momentarily misaligned (FIGS. 4B, 4C and 4D) until they realign in their new positions. It is therefore important that the transition be performed during a fraction of a revolution of gear device 1000, while the idler gear or chain is engaged only with other parts of the effective gear provided by the device. A control system for ensuring correct synchronization of the transition will be described below.

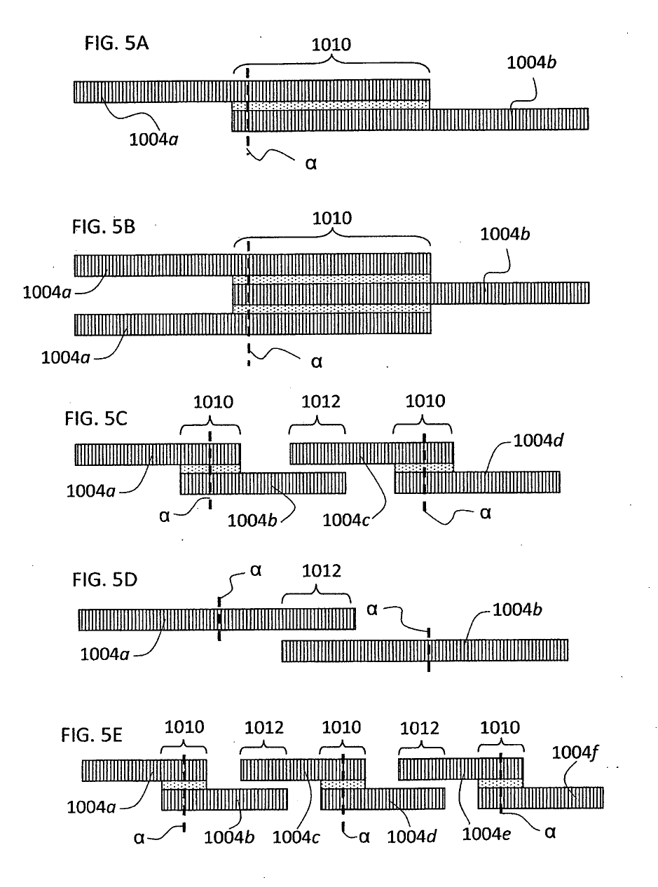

Turning now to FIGS. 5A-5E, these show a number of non-limiting options for layout of tooth sequences to form gear tooth set 1004. Specifically, FIG. 5A shows a layout equivalent to that of FIGS. 1A-4E in which two tooth sequences 1004a and 1004b are interconnected at a region of fixed overlap 1010 and each has a free end which, when wrapped around the variable diameter structure of gear device 1000, forms a variable degree of overlap, i.e., has a variable degree of peripheral coextension, with the other when forming an effective cylindrical gear structure. It should be noted that the tooth sequences may be fused at region 1010 into a single tooth sequence with gear teeth across its entire width, and that the width of region 1010 need not be uniform and need not correspond to the combined width of the two separate tooth sequences 1004a and 1004b.

Also marked on FIG. 5A is a location “α” to which is connected a mechanical linkage (to be described below) of diameter changer 1008. This mechanical linkage transfers a turning moment between the axle and gear tooth sequences 1004a and 1004b, thereby providing the torque transfer between the axle and an interlocking gear. It will be noted that the angular position of the gear teeth of gear tooth sequences 1004a and 1004b vary in their angular position about the axle. This is clearly evident from comparing FIGS. 1A, 2A and 3A where the angular extent of the periphery circumscribed by gear tooth sequence 1004a varies greatly. For this reason, certain preferred implementations of the present invention employ a localized mechanical linkage to a location “α” of the gear tooth sequence, and peripheral forces between the tooth or teeth adjacent to location α and other teeth are transferred along the internal structure of the gear tooth sequence. It should be noted that a more direct mechanical linkage of each individual gear tooth at each required position to the axle, although typically more difficult to achieve, also falls within the scope of the present invention.

FIG. 5B illustrates a configuration functionally equivalent to that of FIG. 5A, but in which gear tooth sequence 1004a is doubled up and deployed symmetrically on each side of gear tooth sequence 1004b. The symmetry of this arrangement may be advantageous in certain implementations of the present invention.

FIG. 5C shows an alternative arrangement which has two mechanical linkages at locations α set 180 degrees apart, and two separate regions of variable overlap, i.e., with a variable degree of peripheral coextension. In this case, the gear tooth sequences are designated 1004a-1004d. When deployed, the two locations α remain fixed 180 degrees apart while the overlap of the gear tooth sequence ends varies to provide the variable effective number of teeth.

The arrangement of FIG. 5D is functionally equivalent to that of FIG. 5C, but employs a single gear tooth sequence 1004a or 1004b attached to each location α. The arrangement of FIG. 5E is similar to that of FIG. 5C, but employs three locations α set at angles separated by 120 degrees, and three regions of variable overlap. In this case, the gear tooth sequences are designated 1004a-1004f.

In each case, with regard to the location α, it should be noted that the motion of this portion of the gear tooth sequences is not necessarily purely radial, and may have an arcuate or more complex path of motion as the effective diameter and effective number of teeth are changed. Furthermore, the location α need not necessarily correspond to a particular tooth, but may instead fall between two teeth.

Although illustrated herein as two or more tooth strips which are juxtaposed along the axial direction of gear device 1000, it should be noted that the regions of fixed and variable overlap are defined only as viewed along the axial direction, and that the tooth sequences may in fact be spaced apart significantly along the axis.

In order to transfer forces along the length of the tooth sequences, each tooth sequence is preferably implemented as a strip of gear teeth interconnected so as to maintain the aforementioned uniform pitch while accommodating a variable radius of curvature between the various states of gear device 1000. Suitable structures for interconnecting the gear teeth to form gear tooth sequences include, but are not limited to, various types of direct hinged interconnections between the teeth, and various linked-chain-type support structures which may be fixedly attached or connected by lateral pins to the individual gear tooth elements. The strip of gear teeth is preferably configured to limit the maximum and minimum curvature of the strip to roughly the range required to accommodate variations between the maximum and minimum diameter of gear device 1000.

It is a particularly preferred feature of certain implementations of the present invention that the diameter changer 1008 is configured to position all of the gear teeth of gear tooth set 1004 on a virtual cylinder coaxial with axle 1002 in each state of gear device 1000. The circular geometry allows gear device 1000 to be used in continuous engagement with a complementary gear wheel and, in the case of chain-based transmission systems, also avoids the shortcomings of the non-circular transmission elements of the prior art discussed above.

The present invention encompasses any and all implementations of the diameter changer which achieve the required motion of gear tooth set 1004 between the different states required. By way of non-limiting examples, it will be appreciated that various known mechanisms for generating variable-diameter pulleys or other cylindrical structures may be arranged to support gear tooth set 1004, thereby serving as a basis for the diameter changer. For example, U.S. Pat. No. 5,830,093 to Yanay discloses an arrangement of slotted disks which provide controlled radial motion of a set of parallel rods, thereby approximating to a variable diameter cylinder. If gear tooth set 1004 is wrapped around such a structure, or engaged in a track which moves together with the rods, the required changing of diameter can be achieved. Mechanical linkage to transfer torque to or from axle 1002 may be implemented simply by anchoring each tooth sequence at an appropriate location to one of the rods.

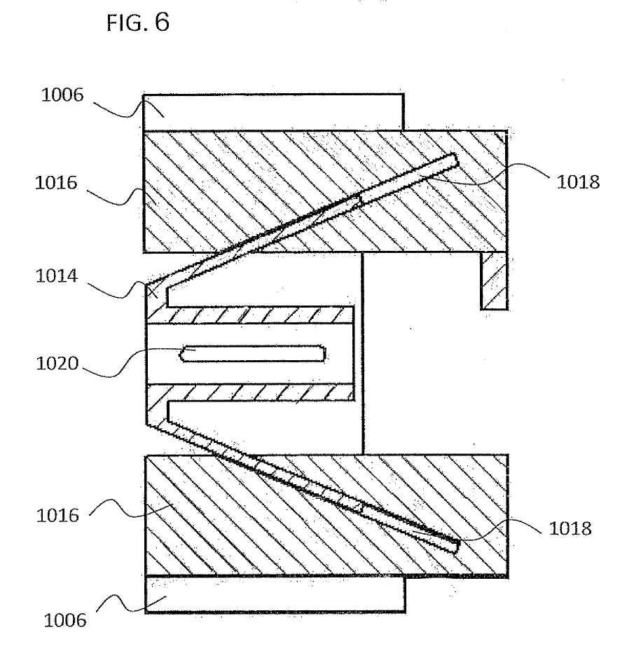

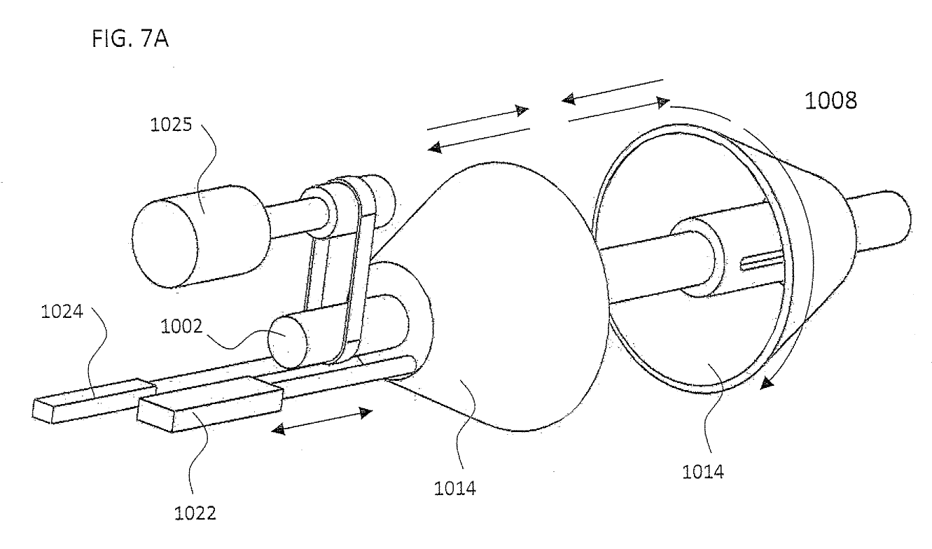

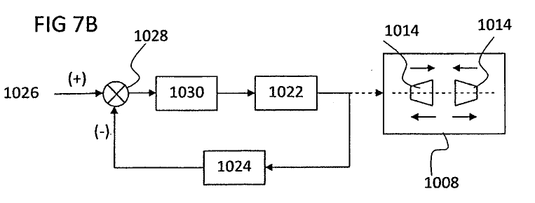

As an alternative preferred example, the present invention will be described further below with reference to various implementations which employ at least one, and typically two, substantially conical elements, each engaged with at least one of the gear tooth sequences such that axial displacement of the substantially conical element changes a distance of the gear teeth of the at least one gear tooth sequence from the axis. A first such implementation is illustrated here schematically with reference to FIGS. 6-7B.

Referring specifically to FIG. 6, there is shown part of a diameter changer including a conical element 1014 which exhibits a smooth conical surface, inside and out. Each gear tooth 1006 of the corresponding gear tooth sequence is formed with a supporting block 1016 which has a slot 1018 for receiving a corresponding part of conical element 1014. The axial position of gear teeth 1006 is fixed by additional alignment features (not shown) while conical element 1014 is axially displaceable. As conical element 1014 moves inwards (to the right as shown), the conical element rides deeper into slots 1018 of supporting block 1016, causing the tooth sequence (e.g., 1004a) to move radially inward, while outward movement (to the left as shown) causes radially outward expansion of the tooth sequence. Slots 1018 are preferably implemented with a flat or low-curvature inward-facing surface and a higher curvature outward-facing surface to maintain a line-of-contact between slot 1018 and the range of curvatures of conical element 1014 which tooth 1006 encounters during radial motion.

Torque-transferring linkage between axle 1002 (here omitted for clarity) and the tooth sequence may be provided either by a pin-and-slot engagement between the conical element and one of teeth 1006 or by a separate radial sliding linkage directly between the axle and one of teeth 1006. In the former case, linkage between the axle and conical element 1014 is typically achieved by engagement of a pin from the axle in a slot 1020 in the central cylindrical collar of conical element 1014.

FIG. 7A illustrates a diameter changer 1008 employing a pair of opposing conical elements 1014 as illustrated in FIG. 6 which are used together to adjust a pair of gear tooth sequences (not shown) such as gear tooth sequences 1004a and 1004b of FIGS. 1A-5A above. FIG. 7A also shows additional components of a control system for controlling operation of the diameter changer. Specifically, there are shown a linear actuator 1022 for displacing conical element 1014 axially to vary the diameter of the gear tooth sequence and an absolute linear encoder 1024 for determining the actual position of the conical element along the axis. A mechanical linkage (not shown) is provided to ensure that the two conical elements 1014 always move symmetrically, i.e., equally but in opposite directions. It will be noted that the linear position along the axis is directly related to the current effective diameter of gear device 1000 and is set only to values corresponding to an integer effective number of teeth. An axle rotation shaft encoder 1025 is deployed to measure the absolute rotational position of axle 1002 at all times.

FIG. 7B illustrates an exemplary implementation of a control loop for controlling this implementation of diameter changer 1008. Here, an input signal 1026 indicative of the currently required diameter of gear device 1000 is fed to a differencer 1028 and then provided as an input to a driver 1030 which generates an output signal to linear actuator 1022, thereby controlling motion of conical elements 1014. Linear encoder 1024 provides negative feedback via differencer 1028, thereby correcting the position of the conical elements in real time until the required position and the actual measured position match exactly.

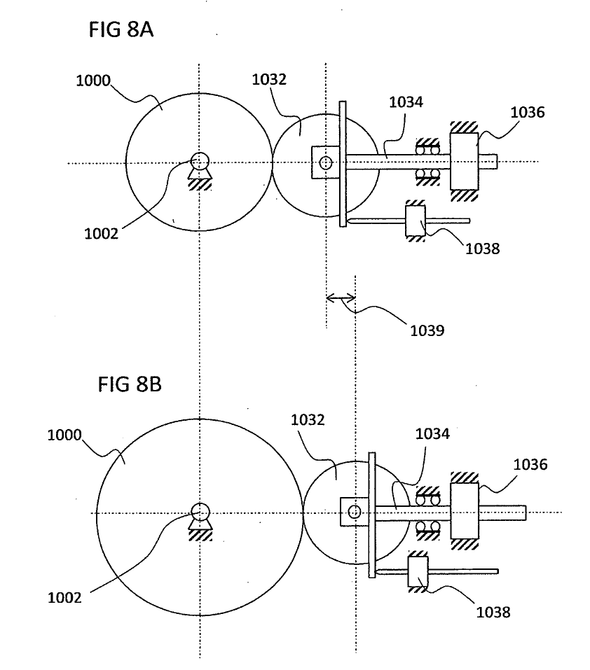

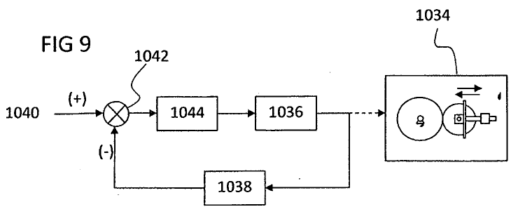

As mentioned earlier, the present invention is applicable both to direct-engagement gear-wheel-based transmission systems and to chain-based transmission systems. The above description with reference to FIGS. 1A-7B is equally applicable to both of these fields of applications. At this point, with reference to FIGS. 8A-9, further details relevant to direct-engagement gear-wheel-based systems will now be described.

Specifically, referring to FIGS. 8A and 8B, it will be noted that the variable diameter of gear device 1000 requires a variable distance between the axes of rotation of gear device 1000 and another gear wheel 1032 engaged therewith. To accommodate this variation in distance, gear wheel 1032 is preferably mounted on a displaceable platform, illustrated here schematically as platform 1034 which is displaced by an actuator 1036. Actuator 1036 may be a linear actuator as illustrated here, or may generate an arcuate motion or any other motion which provides the required variation in spacing between the axes of rotation An encoder, in this case a linear encoder 1038, provides feedback as to the actual current position of gear wheel 1032. FIG. 8A illustrates the transmission system with gear device 1000 in a first state with a small effective diameter and gear wheel 1032 displaced towards axle 1002, and FIG. 8B illustrates the transmission system with gear device 1000 in a second state of larger effective diameter and gear wheel 1032 correspondingly displaced further from axle 1002. The distance of the displacement is designated 1039. Parenthetically, it should be noted that gear wheel 1032 may itself optionally be implemented as a gear device similar to gear device 1000, thereby providing an increased range of transmission ratios and partially offsetting the range of motion required between the axles.

FIG. 9 illustrates an exemplary implementation of a control loop for controlling motion of platform 1034. An input signal 1040 indicative of the currently required spacing of axles between gear device 1000 and idler gear 1032 is fed to a differencer 1042 and then provided as an input to a driver 1044 which generates an output signal to actuator 1036, thereby controlling motion of platform 1034. Encoder 1038 provides negative feedback via differencer 1042, thereby correcting the position of the platform in real time until the required position and the actual measured position match exactly.

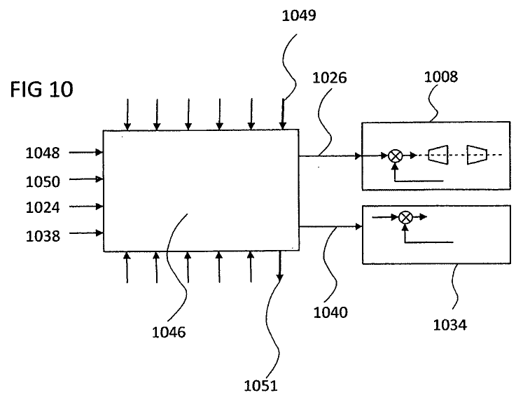

Turning briefly to FIG. 10, it will be appreciated that a transmission system employing gear device 1000 will typically be implemented with a computerized control system, represented here schematically by a processor chip 1046. In a simplest case, inputs to the control system will include a selector input 1048 indicating the currently requested transmission ratio and an input 1050 derived from shaft encoder 1025 to indicate the current angular position of axle 1002, allowing synchronization of ratio shifting within the permitted region of rotation. The exact angular range within which shifting is permitted may be predefined in a look-up table stored in memory for each given state of gear device 1000, or may be derived in real time by the control system by use of a suitably defined formula. The permitted angular range for state shifting is a function of the current diameter of the gear device, and may also depend on other factors such as the current angular velocity of the device. The angles are clearly also different for direct-engagement gear-based transmission systems and for chain-based transmission systems. The control system provides outputs to control the diameter transitions of gear device 1000 and the associated components, such as output 1026 to the control loop of FIG. 7B and output 1040 to the control loop of FIG. 9. The control system preferably also receives inputs generated by various other sensors, such as linear encoder 1024 and encoder 1038, to provide verification that the transmission system is working properly.

In certain cases, the computerized control system may receive various additional inputs, and may also be configured to execute various algorithms specific to the intended application within which the transmission system is to be used. Additionally, or alternatively, the computerized control system may be configured to communicate by wired or wireless communication with other computers or external systems, for example, to provide automated transmission system control slaved to another system or device associated with the transmission system. Additional inputs and outputs may be provided for this purpose, such as telemetry input 1049 and telemetry output 1051.

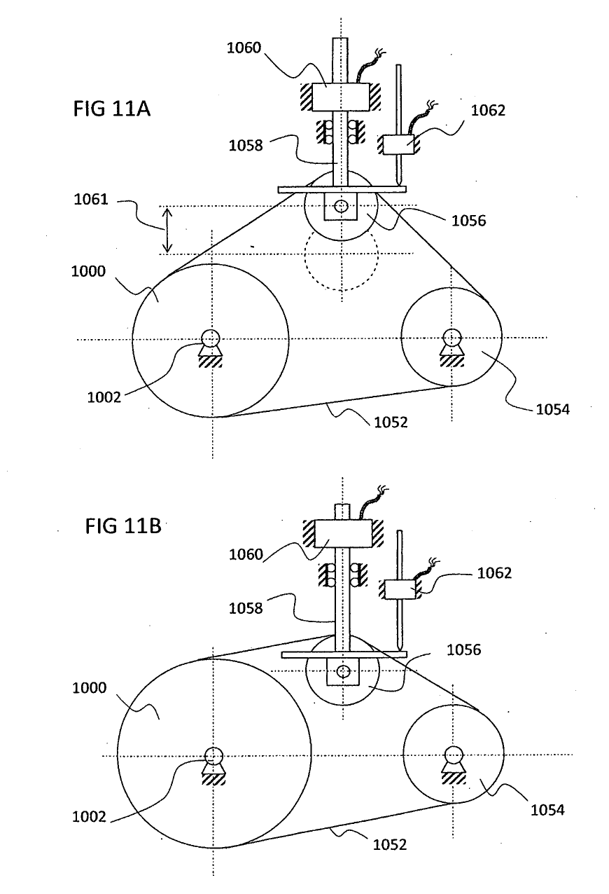

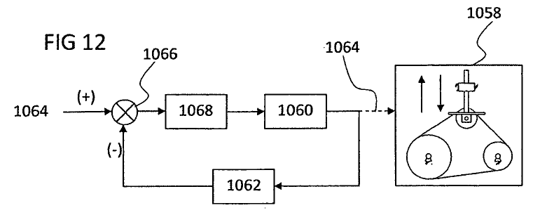

Turning now to FIGS. 11A-12, these parallel the content of FIGS. 8A-9, but instead present a chain-based transmission implementation. Thus, in this case, gear device 1000 is linked via a drive chain 1052 to turn a gear wheel 1054, which may itself be a conventional gear wheel or another gear device according to the teachings of the present invention. FIG. 11A shows gear device 1000 in a first state with a relatively small diameter, while FIG. 11B shows gear device 1000 in a second, larger diameter state. In order to maintain reliable engagement of drive chain 1052 which both gear wheels, a tensioning gear wheel 1056 is provided, mounted on a moving platform 1058 displaced by an actuator 1060 through a range of motion 1061. An encoder 1062 measures the current position of platform 1058.

FIG. 12 illustrates a possible control loop for controlling the movement of platform 1058. An input signal 1064 indicative of the currently required position of platform 1058 is fed to a differencer 1066 and then provided as an input to a driver 1068 which generates an output signal to actuator 1060, thereby controlling motion of platform 1058. Encoder 1062 provides negative feedback via differencer 1066, thereby correcting the position of the platform in real time until the required position and the actual measured position match exactly.

Implementation of a computerized control system for a chain-based transmission system as shown here may be essentially the same as that illustrated in FIG. 10, with the input from encoder 1038 replaced by the input from encoder 1062 and the output 1040 replaced by the output 1064.

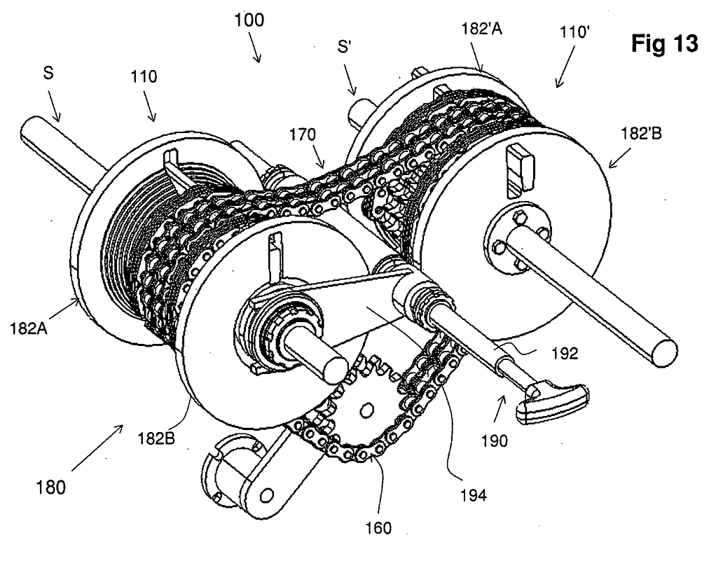

To complete the description, one particular exemplary embodiment will now be described in more detail with reference to FIGS. 13-22. This non-limiting example is arbitrarily shown in the context of a chain-based transmission system, but it will be readily apparent to one ordinarily skilled in the art that the structure is essentially equally applicable to directly-engaged gear-wheel transmission systems.

The embodiment of FIGS. 13-22 is primarily distinguished from the implementations described above by details of the diameter changer. Specifically, in this case, the diameter changer is based on a pair of stepped conical surfaces which are brought together or apart to change the effective diameter and effective number of teeth of the gear device.

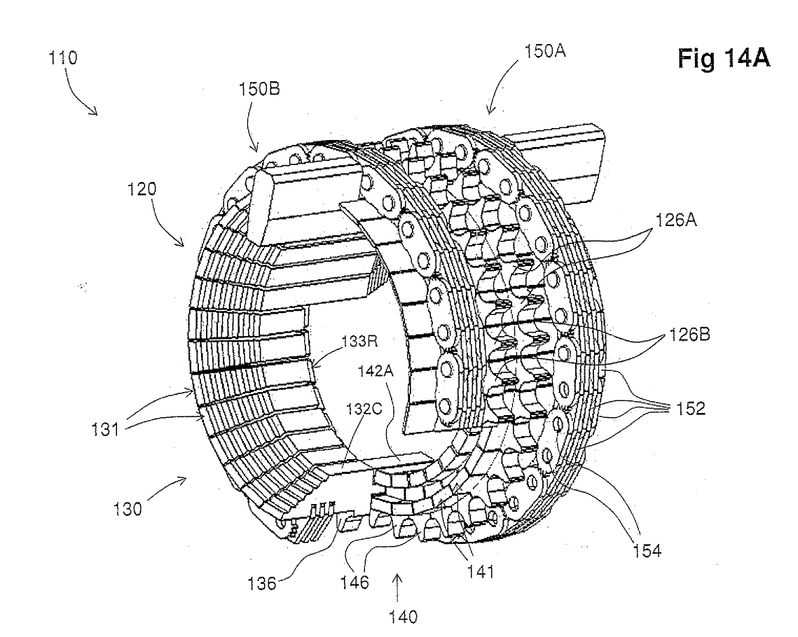

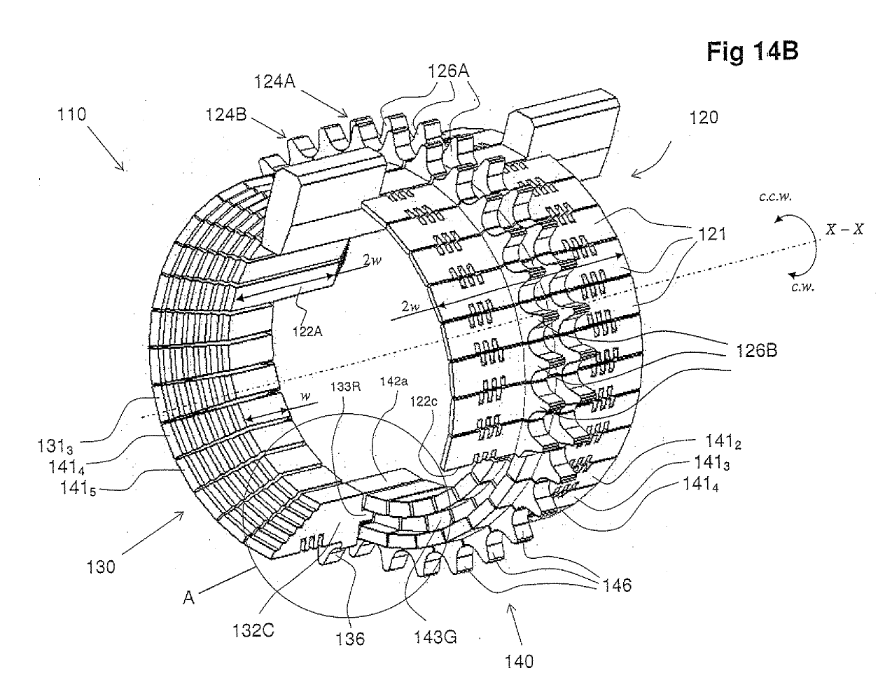

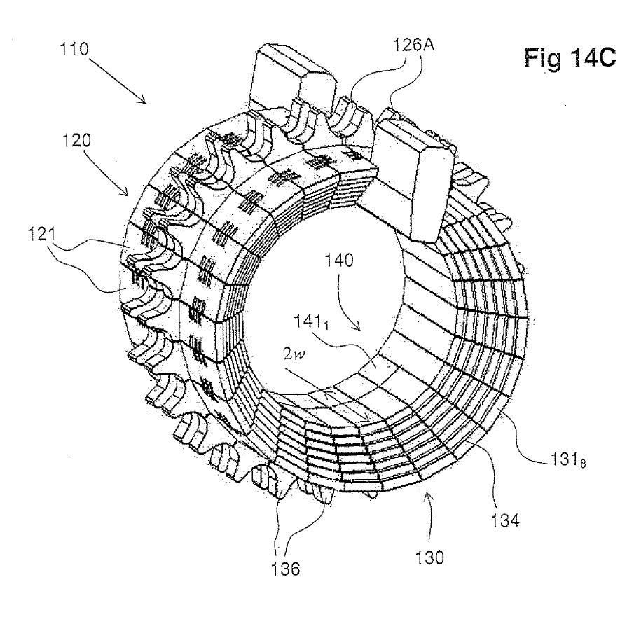

Referring to FIG. 13, this shows an implementation with two similar variable diameter gear devices 110 and 110′ engaged with a common drive chain 170 in which tension is maintained by tension wheels 160. The structure of this implementation of each gear device will be described in further detail with reference to FIGS. 14A-22.

Turning to FIG. 14A, a variable diameter gear device 110 is shown comprising a central segment 120, two lateral segments 130, 140, and a restricting arrangement 150.

The central segment 120 is made of seventeen consecutive full base links 121, each having an extension of a dimension 2W along the axial direction. Each of the full base links 121 is formed with two teeth 126A, 126B, so that two rows 124A and 124B of teeth are circumferentially formed. The first lateral segment 130 is formed of eight consecutive partial base links 131, and the second lateral segment 140 is also formed of eight consecutive partial base links 141, each of the partial base links 131, 141 having an extension W along the axial direction. Each of the partial base links 131, 141 is formed with one tooth 136, 146, such that a single circumferential tooth row 134, 144 is formed on each lateral segment 130, 140 respectively.

The restricting arrangement 150 is adapted both for attachment of the base links 121, 131 and 141 to one another. The restricting arrangement 150 comprises a plurality of restricting plates 152 interconnected by a plurality of pins 154. Every full base link 121 is fitted with six restricting plates 152, three on each side thereof along the axial direction, and each partial base link is fitted with three restricting plates 152, on one side thereof. Thus, all the base links 121, 131 and 141 are interconnected. The restricting arrangement is also adapted for performing pitch restriction, an operation that will be discussed in further detail later.

With reference to FIG. 14B, the gear device 110 is shown in an ‘open’ position, and is shown, for simplification purposes without the restricting arrangement 150 (shown FIG. 14A). In this position, the last partial base link 131₈ of the first lateral segment 130 is aligned with the last partial base link 141₈ of the second lateral segment 140. Thus, the first and last base links 121₁, 121₁₇ may be considered to constitute the first and second end 122a, 122b respectively of the central segment 120. The last partial base links 131₈, 141₈ may be considered to constitute the free ends 132b, 142a of the first and second lateral segments 130, 140 respectively, whereby the free end 132b is spaced from the second end 122b of the central segment 120, and the free end 142a is spaced from the first end 122a of the central segment 120.

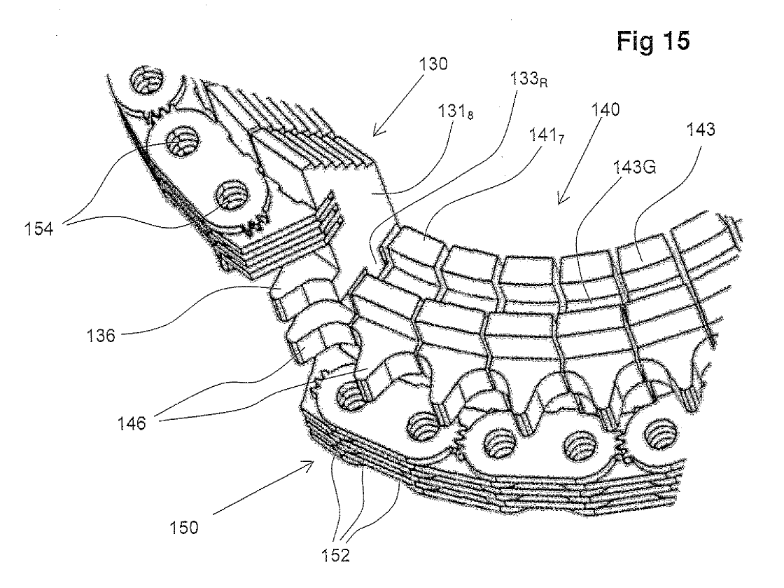

The first and second lateral segments 130, 140 are adapted to be engaged in the axial direction so as to allow the above mentioned sliding engagement in the circumferential direction, whereby the diameter of the gear device 110 may be varied. The engagement mechanism will be later discussed in detail with respect to FIG. 15.

Thus, with reference to FIG. 14C, the gear device 110 is shown in a ‘closed’ position, and is shown, for simplification purposes without the restricting arrangement 150 as in FIG. 14B. In this position, the last partial base link 131₈ of the first lateral segment 130 is aligned with the first partial base link 141₁ of the second lateral segment 140, and the first partial base link 131₁ of the first lateral segment 130 is aligned with the last partial base link 141₈ of the second lateral segment 140. Thus, free end 132b is adjacent the second end 122b, and the free end 142a is adjacent the first end 122a.

### Engagement Mechanism:

Turning now to FIG. 15, an enlargement of the engagement area between the first and second lateral segment 130 140 is shown. The engagement is provided by the first lateral segment 130 being formed with a ridge 133R, adapted to be received within a corresponding groove 143G of the second lateral segment 140. The ridge 133R is constituted by protrusions 133 formed in each of the partial base links 131 of the first lateral segment 130, and the groove 143G is constituted by recesses formed in each of the partial base links 141 of the second lateral segment 140.

The first lateral segment 130 is adapted to slide circumferentially with respect to the second lateral segment 140, by the ridge 133R sliding circumferentially within the groove 143G, allowing changing the diameter of the gear device 110.

### Base Link Structure:

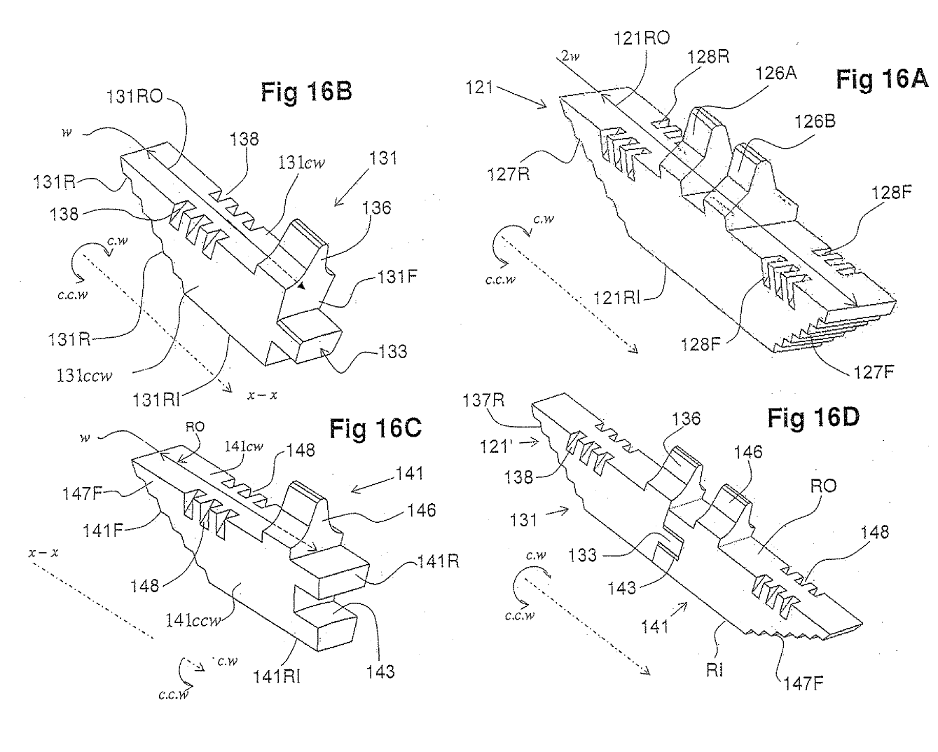

Turning to FIG. 16A, an isometric view of the full base links 121 constituting a part of the first lateral segment 120 is shown. The full base link 121 has an extension 2W along the axial direction. The full base link 121 is further formed with:
a top surface 121RO facing outward in the radial direction;
a bottom surface 121RI facing inward in the radial direction;
a front surface 121F facing the positive axial direction;
a rear surface 121R facing the negative axial direction;
a right side surface 121CW facing the C.W. (clockwise) direction with respect to the central axis X-X; and
a left side surface 121CCW facing the C.C.W. (counterclockwise) direction with respect to the central axis X-X.

It would here be appreciated that the terms ‘top’, ‘bottom’, ‘left’ and ‘right’ are arbitrary terms due to the constant rotation of the gear device 110 in operation configuration. Therefore, the directions referred to hereinafter will be defined by the central axis, i.e. C.W., C.C.W., RO and RI. However, ‘front’ and ‘rear’ directions, denote positive and negative axial direction respectively and will still be referred to as ‘front’ and ‘rear’.

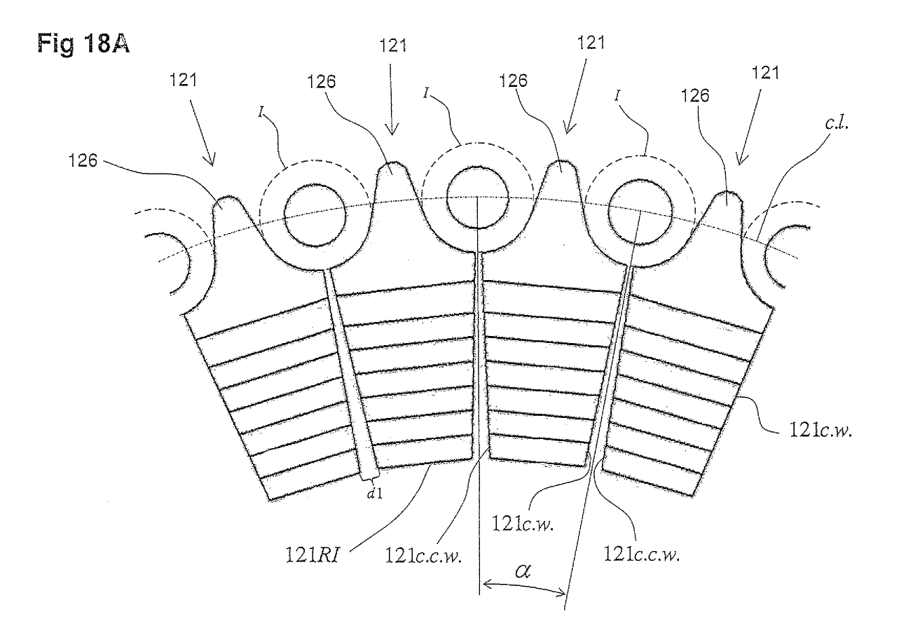

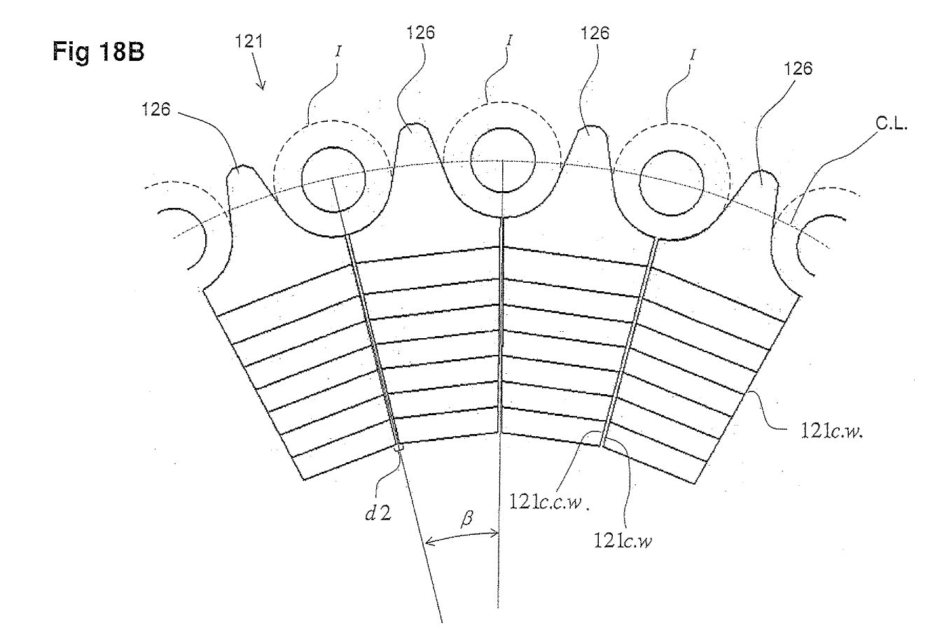

The surfaces 121F and 121R of the full base link 121 are each formed with an incremented slope 127F, 127R respectively. The slopes 127F, 127R are adapted for changing the diameter of the gear device 110. The side surfaces 121CW and 121CCW are tapering towards the axis X-X. The function of the incremented slopes 127F, 127R and of the tapering side surfaces 121CW and 121CCW will be discussed in detail with reference to FIGS. 18A and 18B.

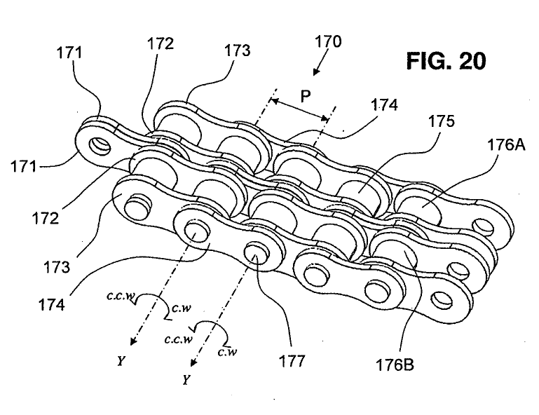

The full base link 121 is formed with two teeth 126A, 126B protruding from the surface 121RO, adapted to constitute a part of the teeth row 124A, 124B, which is in turn adapted for mounting thereon at least a portion of the transmission chain (shown FIG. 20).

The full base link 121 further comprises two sets of slots—slots 128F disposed adjacent the walls 121CW and 121CCW on the positive axial side of the full base link 121, and slots 128R disposed adjacent the walls 121CW and 121CCW on the negative axial side of the full base link 121. The slots 128 are adapted to receive therein the restricting plates 152 as demonstrated in the previous figures.

Turning to FIG. 16B, an isometric view of the partial base links 131 constituting a part of the first lateral segment 130 is shown. The partial base link 131 has an extension W along the axial direction. The partial base link 131 is further formed with:
a surface 131RO facing outward in the radial direction;
a surface 131RI facing inward in the radial direction;
a surface 131F facing the positive axial direction;
a surface 131R facing the negative axial direction;
a side surface 131CW facing the C.W. direction with respect to the central axis X-X; and
a side surface 131CCW facing the C.C.W. direction with respect to the central axis X-X.

The surface 131R of the partial base link 131 is formed with an incremented slope 137R. The slope 137R is adapted for changing the diameter of the gear device 110. The side surfaces 131CW and 131CCW are tapering towards the axis X-X. The function of the incremented slope 137R and of the tapering side surfaces 131CW and 131CCW will be discussed in detail with reference to FIGS. 18A and 18B.

The partial base link 131 is formed with a tooth 136 protruding from the surface 131RO, adapted to constitute a part of a tooth row 134, which is in turn adapted for mounting thereon at least a portion of the transmission chain (shown FIG. 20).

The partial base link 131 is formed with a protrusion 133 protruding from the front surface 131F. Therefore, the partial base link 131 will be referred to hereinafter as a male base link 131 and the first lateral segment will be referred to as a male lateral segment 130. The protrusion 133 constitutes a part of the ridge 133R adapted for engagement between the male lateral segment 130 and the second lateral segment 140.

The male base link 131 further comprises a set of slots 138 disposed adjacent the walls 131CW and 131CCW, located near the negative axial end of the male base link 131. The slots 138 are adapted to receive therein the restricting plates 152 as demonstrated in the previous figures.

Turning to FIG. 16C, an isometric view of the partial base links 141 constituting a part of the second lateral segment 140 is shown. The partial base link 141 also has an extension W along the axial direction. The partial base link 141 is, similarly to the male base link 131, formed with:
a surface 141RO facing outward in the radial direction;
a surface 141RI facing inward in the radial direction;
a surface 141F facing the positive axial direction;
a surface 141R facing the negative axial direction;
a side surface 141CW facing the C.W. direction with respect to the central axis X-X; and
a side surface 141CCW facing the C.C.W. direction with respect to the central axis X-X.

The surface 141F of the partial base link 141 is formed with an incremented slope 147F. The slope 147F is adapted for changing the diameter of the gear device 110. The side surfaces 141CW and 141CCW are tapering towards the axis X-X. The function of the incremented slope 147F and of the tapering side surfaces 141CW and 141CCW will be discussed in detail with reference to FIGS. 18A and 18B.

The partial base link 141 is formed with a tooth 146 protruding from the surface 141RO, adapted to constitute a part of a tooth row 144, which is in turn adapted for mounting thereon at least a portion of the transmission chain (shown FIG. 20).

The partial base link 141 is also formed with a recess 144 at the rear surface 141F thereof. Therefore, the partial base link 141 will be referred to hereinafter as a female base link 141 and the second lateral segment will be referred to as a female lateral segment 140. The recess 144 constitutes a part of the groove 143G adapted for receiving the ridge 133R of the male lateral segment 130.

The female base link 141 further comprises a set of slots 148 disposed adjacent the walls 141CW and 141CCW located near the positive axial end of the female base link 141. The slots 148 are adapted to receive therein the restricting plates 152 as demonstrated in the previous figures.

With reference to FIG. 16D, when a male base link 131 and a female base link 141 are aligned, i.e. the surfaces 131CW and 141CW, and surfaces 131CCW and 141CCW are flush with one another respectively, the male and female base links 131, 141 form a combines link 121′ having an essentially similar construction to that of the full base link 121 of FIG. 16A.

Reverting to FIGS. 14B and 14C, it may be observed that the gear device 110 shown in FIG. 14B comprises only one combined base link 121′ constituted by the last male and female links 131₈ and 141₈ of the male and female lateral segments 130, 140 respectively. On the other hand, with reference to FIG. 14C, all the male base links 131 of the male lateral segment 130 are aligned with the entire female base link 141 of the female lateral segment 140, so as to form eight combined links 121′.

### Gear Geometry and Pitch Restriction:

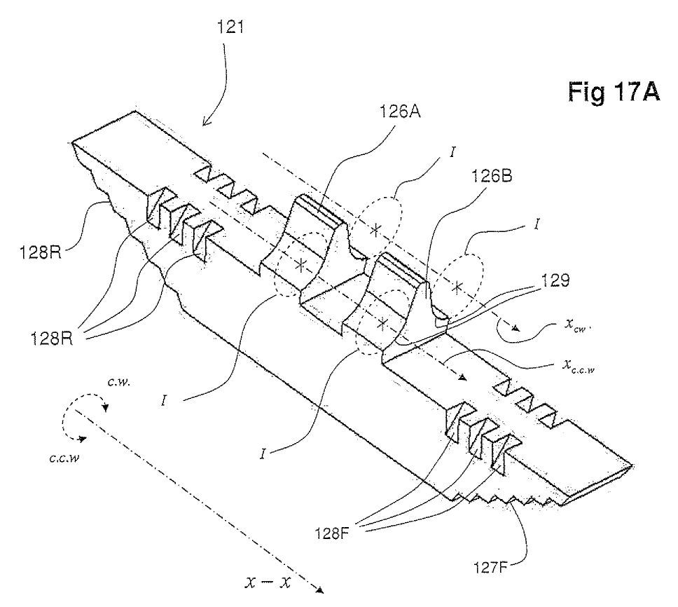

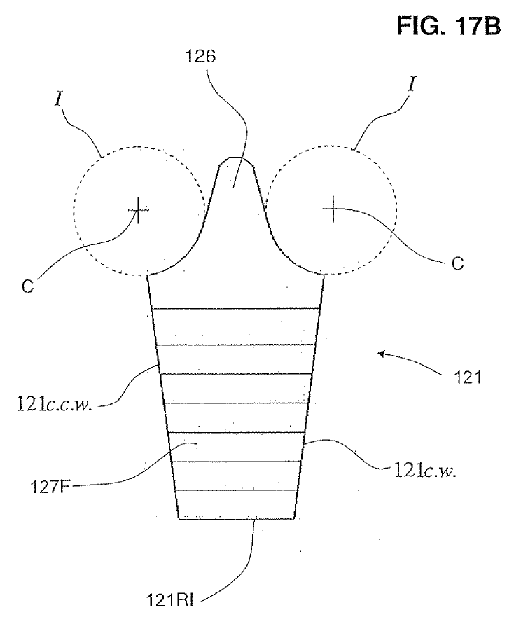

Turning now to FIGS. 17A and 17B, every tooth 126 has two arcuate portions 129 at the base of the tooth 126 disposed on the C.W. and C.C.W. sides of the tooth 126. Each of the arcuate portions 129 constitutes part of an imaginary circle I, having a center point C. The center-points C of two circles I on the C.W. side of the full base link 121 are aligned along an axis X_{CW}, whereas the center-points C of two circles I on the C. C.W. side of the fill base link 121 are aligned along an axis X_{CCW}. Each of the axes X_{CW} and X_{CCW} are essentially parallel to the main axis X-X. The distance along the circumferential direction between the center points C of the C.W. and C.C.W. circles of one base link determines the pitch of the gear device 110.

Turning now to FIGS. 18A and 18B, an enlarged portion of the gear device 110 is shown in both ‘open’ and ‘closed’ positions respectively. In both positions, spacing d₁, d₂ respectively exists between each two adjacent base links 121 due to the tapering of the side surfaces 121CW and 121CCW. Alternatively, it may be considered that the angle between two adjacent base links 126 with respect to the main axis X-X varies from α to β while shifting from an ‘open’ to a ‘closed’ position respectively. The spacing between two adjacent base links prevents the base links 121, 131, and 141 from colliding with one another during a change in diameter.

In each position, the curvature radius, defining the curvature of the gear device 110, and consequently of each of the central, male and female segments 120, 130 and 140, may be determined according to the radius of the curvature line C.L. which is a line representing an interpolation of a circle between all the centers C of the imaginary circles I.

In both the ‘open’ and the ‘closed’ position the full base links 121 are required to be arranged such that the circle I on the C.W. side of one full base link 121 is aligned with the circle I on the C.C.W. side of the adjacent full base link 121, i.e. the centers C of these circles I coincide. This provides that the distance along the circumferential direction between each two centers C is essentially identical Maintaining an identical distance between the centers C is imperative for operation of the gear device 110, since the teeth 126, 136, 146 of the gear are adapted to receive thereon a transmission chain (shown FIG. 20), which has a constant pitch.

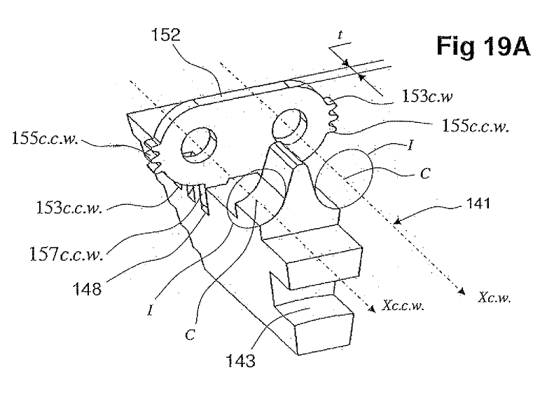

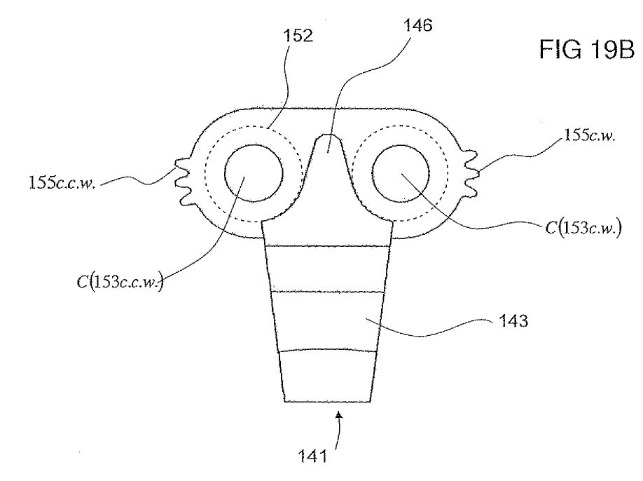

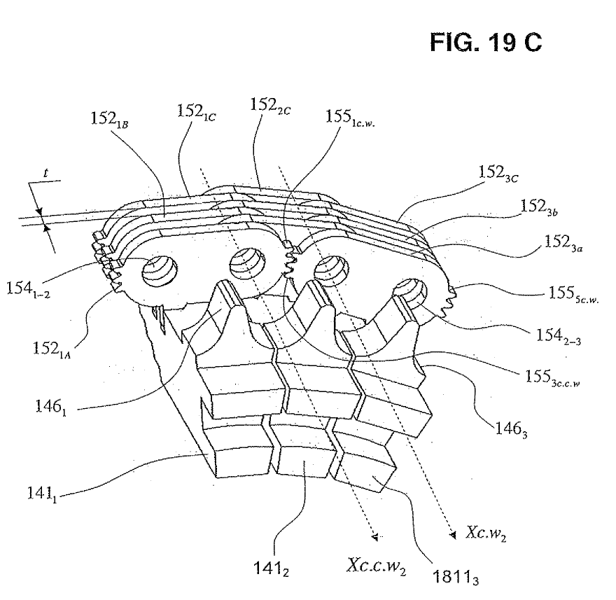

However, it would be appreciated that under normal circumstances, i.e. under no restriction, during a change in diameter, the base links would tend to displace such that the centers C of the circles I would fall out of alignment with one another. The restricting arrangement 150 is adapted for maintaining the constant pitch, i.e. maintain coinciding of the centers C, as will now be explained with reference to FIGS. 19A to 19C.

The restricting plate 152 is formed with two holes 153_{C.W.} and 153_{C.C.W.}, two cog portions 155_{C.W.} and 155_{C.C.W.} and two attachment portions 157_{C.W.} and 157_{C.C.W.}. The restricting link 152 has a thickness t along the axial direction. The restricting link 152 is shown mounted onto the female base link 141, such that the attachment portions 157_{C.W.} and 157_{C.C.W.} thereof are received within the slots 148 of the female base link 141. In this position, the centers of the holes 153_{C.W.} and 153_{C.C.W.} are aligned with the centers C of the imaginary circles I defined by the arcuate portions 129 of the tooth 146.

Turning to FIG. 19C, the female base links 141₁ to 141₃ are each mounted with three restricting plates 152₁ₐ to 152_{1c}, 152₂ₐ to 152_{2c} and 152₃ₐ to 152_{3c} thereon respectively, having a spacing t along the axial direction therebetween. Thus, when the restricting plates 152 are interconnected, the restricting plates 152_{1b} and 152_{1c} are received within the spaces t of the restricting plates 1522a to 152_{2c} of the second female link 141₂. In this position, the cog portions 155_{1C.W.} of the restricting plates 152 mounted on the first female base link 141₁ mesh with the cog portions 155_{3C.C.W.} of the restricting plates 152 mounted on the third female base link 141₃.

In addition, when the restricting plates 152 are interconnected by the pins 154, the central axis of the pins 154₁₋₂ and 154₂₋₃ are aligned with the holes 153_{1C.W.} and 153_{2C.C.W.}, and 153_{2C.W.} and 153_{3C.C.W} respectively. This consequently leads to alignments with the centers C of the circles I. It would also be appreciated that the restricting arrangement 150 is thus able to maintain a constant pitch P regardless of the shape and curvature taken on by each segment 120, 130, and 140 of the gear device 110.

Turning to FIG. 20, a standard double transmission chain 170 is shown comprising a set of chain plates 171-174, a set of rollers 176_{A} and 176_{B} mounted correspondingly on a set of holding pins 177 as known per se. The axis Y of each holding pin 177, and consequently of each roller 176_{A}, 176_{B} maintain a fixed distance therebetween referred to as the pitch P. The pitch P remains essentially constant throughout the entire transmission chain 170.

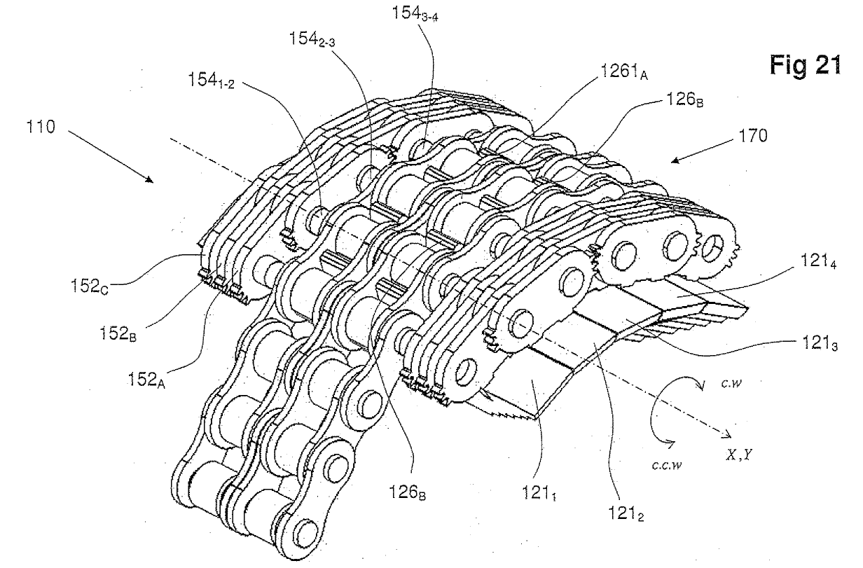

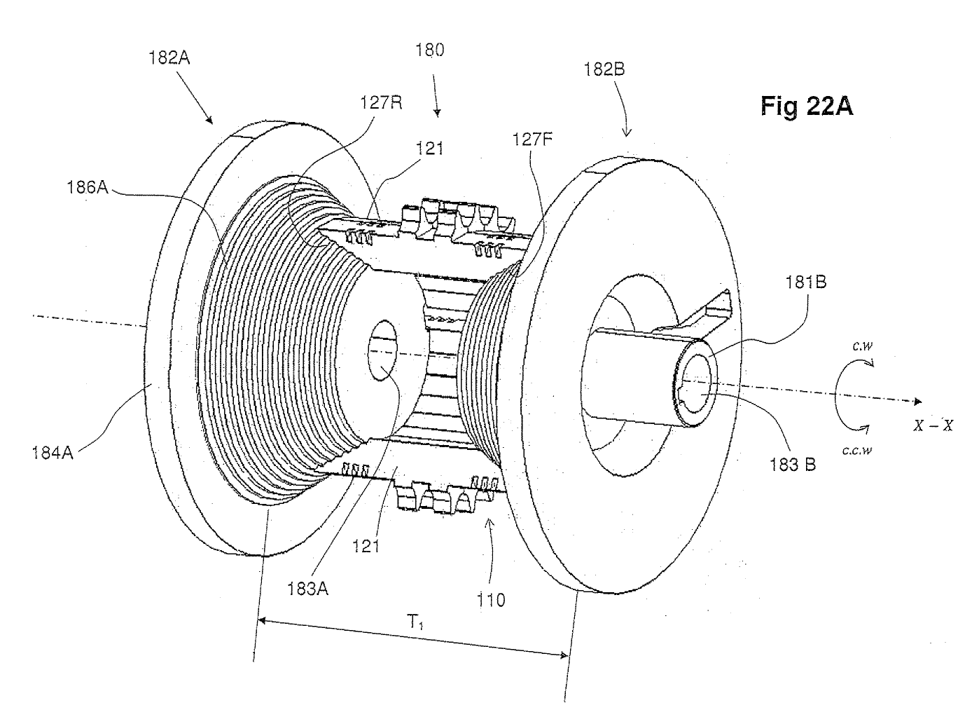

Turning now to FIG. 21, the transmission chain 170 is shown mounted on a portion of the gear device 110. In this position, the central axes Y of the rollers 176 of the transmission chain 170, the centers C of the circles I of the teeth 126, the holes 153 of the restricting plates 152 and the axes x of the connecting pins 154 are all aligned along a mutual axis. It would also be appreciated that since the pitch P remains essentially constant, the gear device 110 would always ‘fit’ the transmission chain 170.

### Diameter Changing:

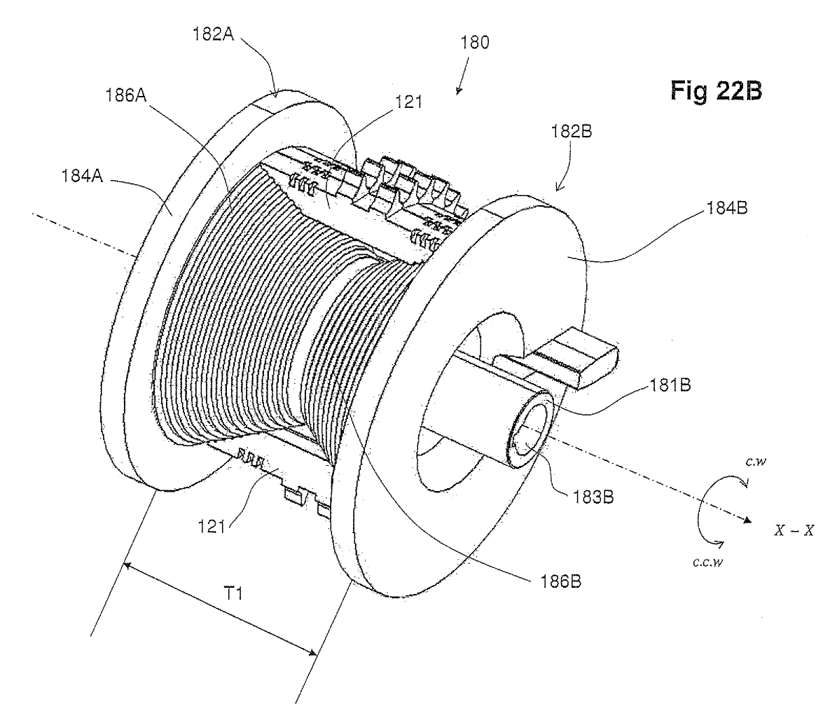

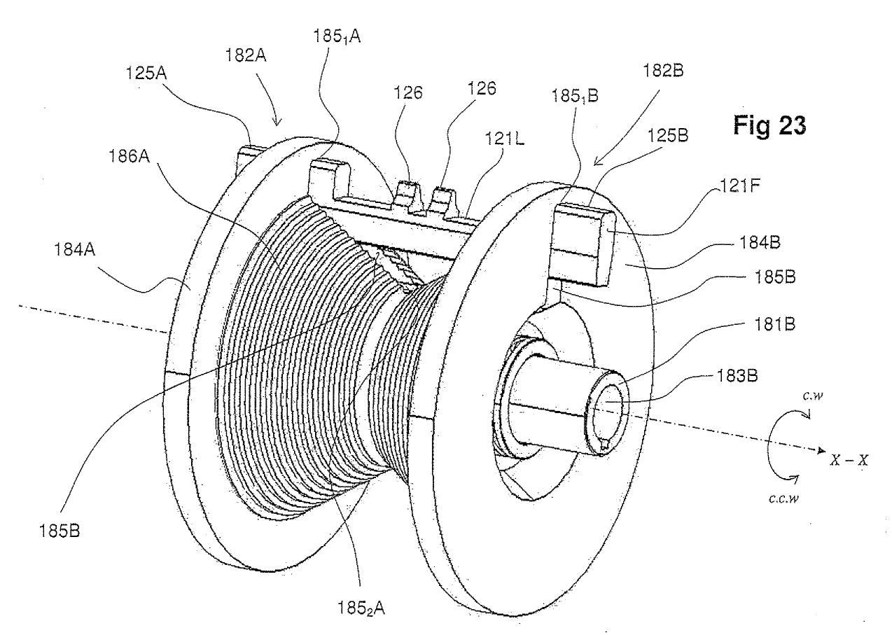

Turning to FIGS. 22A an 22B, a diameter changing mechanism 180 is shown comprising two conical members 182A and 182B respectively, adapted for seating of the gear device 110 thereon, on the radially outward portion RO thereof. Each of the conical members 182 is formed with a base 184 and a conical incremented slope 186. Each member is integrally formed with a cylindrical connector 181 having a bore 183 adapted to receive a driving shaft therein, to be rotated thereby.

When the gear device 110 is seated on the diameter changing mechanism 180, each of the base links 121, 131 and 141 of each of the segments 120, 130 and 140 respectively is seated on the incremented slope 186, such that the incremented slopes 127, 137, 147 thereof are mated with the incremented slope 186.

In FIG. 22A, the gear device 110 is shown in an essentially ‘closed’ position, corresponding to the position shown in FIG. 14C. In this position, the bases 184 of the conical members 182 are at a distance T₁ from one another, and the base links 121, 131 and 141 are positioned adjacent the axis X-X (at a distance corresponding to R=D₂/2). It would also be observed, that due to the spacing T₁ between the conical members 182A and 182B, the base links 121, 131 are seated one the incremented surface 186 in a location spaced from the base 184.

Turning to FIG. 22A, in order to increase the diameter of the gear device 110, the conical members 182 are brought closer together to a distance T₂ between the bases 184 thereof, such that the base links 121, 131 and 141 are forced to ‘climb up’, i.e. displace radially outwards. This in turn, leads to an increase in the diameter of the gear device 110. Thus, as shown in FIG. 22B, the gear device 110 is in an essentially ‘closed’ position, corresponding to the position shown in FIG. 14B. In this position, the base links 121, 131 and 141 are positioned farther away from the axis X-X (at a distance corresponding to R=D₁/2). It would also be observed, that due to the essentially little spacing T₂ between the conical members 182A and 182B, the base links 121, 131 are seated one the incremented surface 186 in a location adjacent the base 184.

In order to decrease the diameter of the gear device 110, an essentially reverse operation is required, i.e. the conical members 182 are brought further apart to the distance T₁ between the bases 184 thereof, such that the base links 121, 131 and 141 are forced to ‘climb down’, i.e. displace radially inwards. As opposed to an increase in diameter, during a decrease, the base links 121, 31 and 141 are forced radially inward by the pressure of the transmission chain 170 mounted on the gear device 110.

It would also be appreciated here that using the diameter changing mechanism 180 disclosed above, the gear device 110 may assume a variety of diameters, depending on the distance T between the bases 184 of the conical members 182. Thus, for example, the diameter may be increased/decreased by one increment at a time.

It would be appreciated that the incremented slope 186 of the conical members 182 and the incremented slopes 127, 137 and 147 of the base links 121, 131 and 141 respectively may be of various corresponding designs. Furthermore, the orientation of the conical members 182 with respect to one another as well as the manner in which they are operated (electrically, hydraulically etc.) may vary as well known in common practice.

### Operation:

Turning now to FIG. 23, upon rotation of the conical members 182 by the driving shaft, torque is required to transfer from the conical members 182 to the gear device 110. Thus, the diameter changing mechanism 180 also functions as a torque transferring mechanism.

For this purpose, each conical member 182 is further formed with a guiding slot 185 extending along the radial direction between a first closed end 185₁ and a second closed end 185₂ thereof. One of the base links 121L, is formed with prolonged extensions 125A and 125b to form a rod, the extensions 125 being sufficiently long so as to be received within the guiding slot 185. The extensions 125 are also designed to have a cross-section geometry corresponding to that of the guiding slot 185.

In operation, upon rotation of the driving shaft, the conical members 182 are set in rotary motion. Since the extensions 125 are received within the guiding slot 185, rotary motion of the conical members 182 entails a rotary motion of the base link 121L. In turn, since all the base links 121, 131, and 141 are interconnected by the restricting arrangement 150, rotary motions of the base link 121L, entails the rotation of the entire gear device 110.

Reverting to FIGS. 22A and 22B, as previously described, upon changing the diameter of the gear device 110, the base links 121, 131 and 141 are forced to ‘climb up’ or ‘climb down’ the incremented slopes 186 of the conical members 182. However, ‘climbing’ of the gear device 110 in both directions is limited by the closed ends 185₁ and 185₂. Thus, when increasing the diameter of the gear device 110, the base link 121L is able ‘climb up’ only up to a point where the RO surface thereof abuts the closed end 185₁, and when decreasing the diameter of the gear device 110, the base link 121L is able ‘climb down’ only up to a point where the RI surface thereof abuts the closed end 185₂. Limiting the movement of the base link 121L reflects on all the gear device 110, and therefore provides a diameter limitation thereto.

It would be appreciated that the length of the guiding slot 185 may be determined to correspond to the number of base link 121, 131 and 141 of the gear device 110, and may be designed so as to allow, at the least, an overlap of a desired number of teeth 136, 146 between the first and second segment 130, 140 in the ‘open’ position. Furthermore, the guiding slot 185 may be designed such as to prevent the gear device 110 from assuming a diameter exceeding maximal diameter thereof i.e. maintaining, at the least, an overlap of one tooth 136, 146 between the first and second segment 130, 140 respectively, in the ‘open’ position.

### Combined Operation:

It will be appreciated that gear device 110, with suitable adaptation of the form of the teeth used, may be used in any and all configurations of a transmission system according to the present invention, including a direct-engagement gear-wheel transmission as illustrated above with reference to FIGS. 8A-9 and a chain-based transmission system as illustrated above with reference to FIGS. 11A-12. Furthermore, as mentioned above, these system may each be implemented using a single gear device according to the present invention, or using two or more thereof.

Referring now again to FIG. 13, a transmission assembly 100 is shown comprising two variable diameter segmented gear devices 110 and 110′, two diameter changing mechanisms 180 and 180′, a transmission chain 170, a tension wheels 160, a regulation arrangement 190, and two shafts S and S′.

In assembly, the conical members 182 are mounted on the driving shaft S, and the conical members 182′ are mounted on the driven shaft S′. The gear devices 110, 110′ are seated on the corresponding conical members 182 and 182′ respectively. The transmission chain 170 is mounted on the gear devices 110, 110′ and the tension wheel 160 is placed so as to provide tension in the transmission chain 170.

The regulation arrangement 190 comprises a main shaft 192, and is formed with an arm 194 which is articulated to the diameter changing arrangement 180. The regulation arrangement 190 is adapted to pull the conical members 182 apart, or bring them closer together so as to change the diameter of the gear device 110. This is achieved by displacing the arm 194 along the axial direction.

According to a specific design (not shown), the diameter regulation arrangement 190 may also be connected in a similar matter, i.e. using an arm 194′ (not shown), to the second gear device 110′, thereby maintaining a corresponding change of the diameter of the second gear device 110′ upon a change in diameter of the first gear device 110.

However, it would be readily appreciated that each of the gear devices 110, 110′ may be fitted with an individual regulation arrangement 190, 190′ respectively, allowing each gear device 110, 110′ to change its diameter irrespective of the other. This, in turn, may provide a wide variety of transmission ratios.

It will be appreciated that the above descriptions are intended only to serve as examples, and that many other embodiments are possible within the scope of the present invention as defined in the appended claims.

What is claimed is:

1. A variable diameter gear device for use in a variable ratio transmission system, the variable diameter gear device comprising:
(a) an axle defining an axis of rotation;
(b) a gear tooth set deployed around said axle, said gear tooth set including at least:
(i) a first displaceable gear tooth sequence including a plurality of gear teeth spaced at a uniform pitch, and
(ii) a second displaceable gear tooth sequence including a plurality of gear teeth spaced at said uniform pitch; and
(c) a diameter changer mechanically linked to said axle and to said gear tooth set so as to transfer a turning moment between said axle and said gear tooth set, said diameter changer configured to displace said gear tooth set so as to vary a degree of peripheral coextension between at least said first and said second gear tooth sequences, thereby transforming the gear device between:
(i) a first state in which said gear tooth set is deployed to provide an effective cylindrical gear with a first effective number of teeth, and
(ii) a second state in which said gear tooth set is deployed to provide an effective cylindrical gear with a second effective number of teeth greater than said first effective number of teeth.

2. The device of claim 1, wherein said diameter changer is further configured to displace said gear tooth set so as to vary a degree of peripheral coextension between at least said first and said second gear tooth sequences so as to selectively transform the gear device to each of a plurality of intermediate states each providing an effective cylindrical gear with a corresponding integer effective number of teeth assuming a value between said first and said second effective numbers of teeth.

3. The device of claim 1 wherein said diameter changer is configured to position all of said gear teeth of said gear tooth set on a virtual cylinder coaxial with said axle in each of said first and said second states.

4. The device of claim 1, wherein each of said tooth sequences is implemented as a strip of gear teeth interconnected so as to maintain said uniform pitch while accommodating a variable radius of curvature between said first and said second states.

5. The device of claim 4, wherein said diameter changer transfers a turning moment between both said first and said second gear tooth sequences and said axle via a single mechanical linkage.

6. The device of claim 4, wherein said diameter changer transfers a turning moment between said first and said second gear tooth sequences and said axle via separate mechanical linkages angularly spaced around said axle.

7. The device of claim 4, wherein said gear tooth set has a single region with a variable degree of peripheral coextension between said gear tooth sequences.

8. The device of claim 4, wherein said gear tooth set has a plurality of regions with a variable degree of peripheral coextension between said gear tooth sequences.

9. The device of claim 1, wherein said diameter changer includes at least one substantially conical element engaged with at least one of said gear tooth sequences such that axial displacement of said substantially conical element changes a distance of said gear teeth of said at least one gear tooth sequence from said axis.

10. The device of claim 9, wherein said substantially conical element has a stepped conical surface.

11. The device of claim 9, wherein said substantially conical element has a smooth conical surface.

12. The device of claim 1, wherein said diameter changer includes at least one pair of slotted disks associated with said axle, and a plurality of pins associated with at least one of said gear tooth sequences and engaged in said slots, said slotted disks being configured such that relative rotation of said slotted disks about said axis changes a distance of said gear teeth of said at least one gear tooth sequence from said axis.

13. The device of claim 1, wherein said diameter changer includes a sensor deployed to generate an output indicative of an effective diameter of the variable diameter gear device, said diameter changer being responsive to said output to adjust said gear tooth set to provide an effective cylindrical gear with an integer effective number of teeth.

14. The device of claim 1, wherein said diameter changer includes:
(a) a sensor deployed to generate an output indicative of a current angular position of said axle; and
(b) a controller responsive to said output to selectively perform said transforming while said axle is within a permitted range of angular positions.

15. The device of claim 1, further comprising:
(a) an idler gear wheel deployed for rotation about an idler axle, said idler gear wheel including a plurality of gear teeth configured for engaging said gear wheel sequences; and
(b) an idler displacer associated with said idler axle and configured to move said idler axle so as to maintain engagement of said idler gear wheel with said gear tooth set while said effective number of teeth is varied.

16. The device of claim 1, further comprising a chain deployed in engagement with a plurality of gear teeth of said gear tooth set so as to maintain a driving engagement with said gear teeth during transformation between said first and said second states.
